(19) United States
(12) Patent Application Publication
(10) Pub. No.: US 2008/0062614 A1
(43) Pub. Date: Mar. 13, 2008

(54) Devices with ultrathin structures and method of making same

(75) Inventor: Dan V. Goia, Potsdam, NY (US)

Correspondence Address: GREENBERG TRAURIG, LLP, ONE INTERNATIONAL PLACE, 20th FL, ATTN: PATENT ADMINISTRATOR, BOSTON, MA, 02110, US

(73) Assignee: NanoDynamics, Inc.

(21) Appl. No.: 11/901,434

(22) Filed: Sep. 14, 2007

Related U.S. Application Data
(63) Continuation of application No. PCT/US06/09523, filed on Mar. 15, 2006.
(60) Provisional application No. 60/661,717, filed on Mar. 15, 2005.

(51) Int. Cl. H01G 4/06; B32B 5/16

(52) U.S. Cl. 361/311; 427/79; 428/328; 428/332; 428/336

(57) ABSTRACT

A method of making multilayer electronic devices, such as capacitors and varistors, is provided, wherein nanosized particles are assembled into a densely packed thin film on a dielectric substrate, and then sintered to form an electrode less than about 700 nm in thickness.

### RELATED APPLICATIONS

This application is a continuation of PCT International Patent Application Number PCT/US2006/009523, filed Mar. 15, 2006, which claims the benefit of U.S. Provisional Application Ser. No. 60/661,717, filed Mar. 15, 2005, and the entirety of these applications are hereby incorporated herein by reference for the teachings therein.

### FIELD OF THE INVENTION

The present invention relates to methods of making electrical devices in general, and capacitors in particular, that feature ultrathin conductive films.

### BACKGROUND OF THE INVENTION

Metallic particles are used extensively in the electronic industry to construct conductive layers, which may be either intrinsic elements of various components (capacitors, varistors, actuators, etc.) or connecting paths between these components within complex circuits. To a very large extent, these metallic layers are obtained via thick film technology, an approach in which metallic particles are dispersed in high viscosity vehicles (e.g., pastes) and then deposited in the desired patterns by screen-printing. The resulting deposits of well-packed metallic particles are subsequently converted into solid, continuous conductive layers by removing the organic matter and then sintering the solids at appropriate temperatures (see, e.g., FIG. 3a).

Using a similar but more sophisticated approach, multi-layer devices and structures having a large number of alternating metallic and ceramic layers may be constructed (see, e.g., FIGS. 1 and 2). For example, most current state-of-the-art multilayer ceramic capacitor (MLCC) manufacturing methods employ the screen-printing of viscous electrode precursors, typically metallic pastes, onto the surface of a dielectric “green” tape, using a very fine printing screen in which the desired electrode pattern is pre-etched. The steps involved in a typical screen-printing process are illustrated in FIG. 2. In the first step, a large piece of dielectric tape (typically on the order of 25×25 cm) is laid out using pressure on the flat face of a die on a moving stage. The stage is then moved to the next position in which a metal paste is pushed with a squeegee through a printing screen, whose pattern, size, and geometry correspond to those of the desired final electrodes. In this position the correct offset between the adjacent electrode layers is achieved by simply shifting the position of the screen for every other set of electrodes. After the printed metallic paste layers are dried in the next position, the stage returns to the initial position where another dielectric tape is laid out in the top of the first one, again using pressure to ensure good bonding between the dielectric layers and an effective confinement of the printed metallic layers in the body of the ceramic. This cycle is repeated until the desired number of electrodes is obtained. The final stack of alternating metallic and dielectric layers is cut to yield individual “green” MLCCs.

The present state-of-the-art technology is capable, for example, of building multilayer ceramic capacitors containing up to 800 alternating dielectric layers (as thin as 2 μm) with metallic electrodes (as thin as 0.8 μm, at an average cost of less than one cent per unit (see, e.g., FIG. 3b). The increased volumetric density of capacitance allows a more efficient use of space on circuit boards and facilitates the miniaturization of electronic components and devices.

Despite the impressive achievements of the thick film technology, there is still a need to further to reduce the thickness of the metallic layers incorporated in various devices. For example, in the case of noble metal-based MLCC's, a four-fold reduction in the thickness of the metallic electrodes (from ca. 800 nm to ca. 200 nm) would reduce the cost of the expensive metals used by 75%. Furthermore, thinner metallic layers would diminish the mechanical stresses developed in the multi-layered structures, making it possible to decrease the thickness of the dielectric layers and increase the number of layers in a given volume. The combination of these factors should significantly facilitate further reductions in cost and further miniaturization of electronic devices and their components, particularly multilayer devices such as varistors, ESD and EMI filters, and MLCCs.

Unfortunately, efforts to reduce the thickness of electrodes using the present thick-film technology are hindered by the difficulty of further reducing the volume of paste deposited onto substrates by the screen-printing technique, even when using the finest mesh screens available. This impasse is illustrated in FIG. 4, which shows a screen-printed layer of monodisperse, non-agglomerated Ag—Pd particles with a diameter of ˜130 nm on a dielectric tape, obtained using one of the finest screens available (600 mesh). As shown in FIG. 4, the thickness of the well-packed deposit of particles is still 2-3 times greater than is actually necessary to obtain a continuous metallic layer after sintering. Considerable efforts in reducing the thickness of the electrodes have been focused on perfecting the formulation of the pastes and the screen-printing process. However, these refinements have brought only modest incremental improvements, and the electronic industry is seeking alternative ways to achieve more dramatic reductions in the dimensions of electronic devices and implicitly in the thickness of the metallic layers. One alternative often considered is a thin film technology in which thin, dense, and conductive metallic films are generated by the condensation of metal atoms from the gas phase. However, the inability of the chemical or physical vapor deposition methods to control directionally the flux of atoms and to obtain sophisticated patterns on a desired substrate without significant metal losses makes them unsuitable for low cost, high throughput mass production of multi-layer structures. Furthermore, the fully sintered metallic layers deposited by vapor deposition methods may create problems when used in conjunction with “green” ceramic layers, as the subsequent sintering of the latter may generate significant stresses at the metaUceramic interface and affect the structural integrity of complex multi-layer structures.

### BRIEF DESCRIPTION OF THE FIGURES

FIG. 1 illustrates a multilayer ceramic capacitor produced in accordance with one embodiment of the present invention.

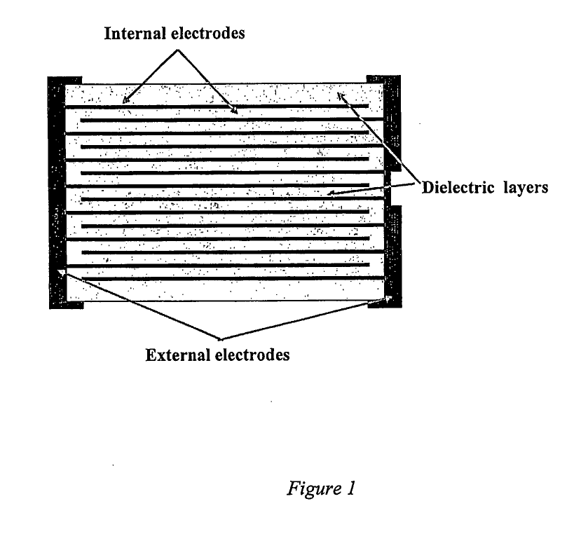

FIG. 2 shows a typical screen-printing process for producing MLCC.

FIG. 3A is a schematic of the thick film technology and 3B is a micrograph of a cross-section view of a MLCC, with a human hair superimposed for scale.

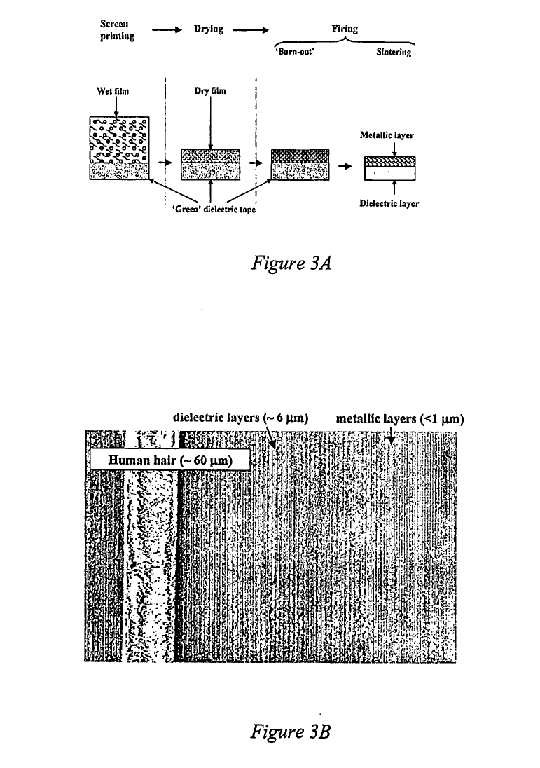

FIG. 4 shows a cross-section view of a layer of Ag—Pd particles obtained using the prior art screen-printing process.

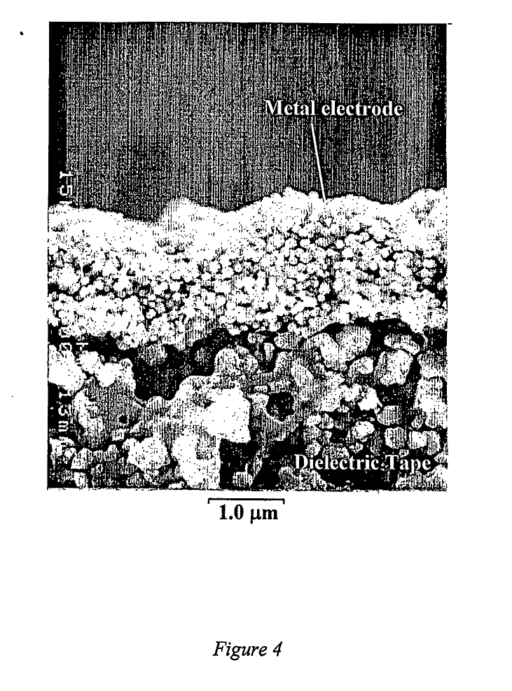

FIG. 5 illustrates changes in the standard redox potentials of a gold solute species and ascorbic acid as a function of pH.

FIG. 6 shows a plurality of monodisperse gold particles of various sizes.

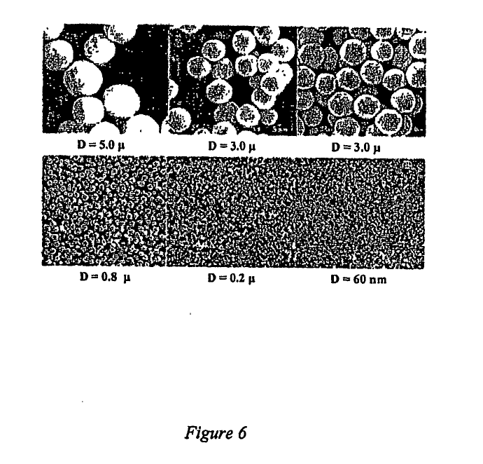

FIG. 7 shows examples of highly dispersed Ag and Ag—Pd nanoparticles suitable for use in the present invention.

FIG. 8 illustrates Average Particle Coordination Number (APCN) as a function of the number of particle layers in a 3-dimensional arrangement of spheres.

FIG. 9 illustrates the agglomeration properties of Ag and Ag—Pd nanoparticles suitable for use in the present invention.

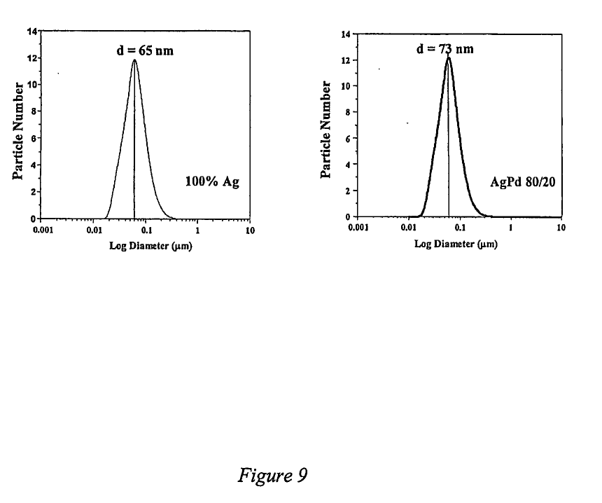

FIG. 10 shows the properties of Ag and Ag—Pd nanoparticles suitable for use in the present invention.

FIG. 11 shows the X-ray diffraction analysis of Ag and Ag—Pd nanoparticles suitable for use in the present invention.

FIG. 12 shows the oxidation properties, as reflected in changes in weight with rising temperature, of Ag—Pd nanoparticles suitable for use in the present invention.

FIG. 13 shows top-view of a well-packed deposit of ˜70 nm Ag particles obtained on a glass slide by the dipping process of the present invention.

FIG. 14 shows a cross-section view of a well-packed deposit of ˜70 nm Ag—Pd (80/20) particles obtained on a glass slide by the dipping process of the present invention.

FIG. 15 shows a cross-section view of a well-packed deposit of ˜70 nm Ag—Pd (80/20) particles obtained on a glass slide by the dipping process of the present invention.

FIG. 16 illustrates the deposition of a thin layer of metallic particles on a carrier film in accordance with one embodiment of the present invention.

FIG. 17 illustrates a schematic representation of the hot-press transfer of the metallic layer onto the dielectric tape according to one embodiment of the present invention.

FIG. 18 illustrates a hot-pressing film transfer process of stacking metallic and dielectric layers.

### DETAILED DESCRIPTION OF THE INVENTION

As used herein and in the appended claims, the singular forms “a,” “an,” and “the” include plural references unless the context clearly dictates otherwise. Thus, for example, reference to “a particle” includes a plurality of such particles, and reference to “the layer” is a reference to one or more layers and equivalents thereof known to those skilled in the art, and so forth. The terms “nanoparticles” and “nanosized particles” are used interchangeably, and refer to particles having a diameter less than about 100 nm. All publications, patent applications, patents, and other references mentioned herein are incorporated by reference in their entirety.

The present invention provides a method for producing devices having ultrathin structures (e.g., conductive metallic layers), with thickness between about 2 and about 700 nm, and preferably between about 2 and about 200 nm, by depositing a suspension of well-dispersed and uniform nanoparticles onto a substrate, and transforming the suspension of particles into an ultrathin, well-packed deposit that may subsequently be converted into a continuous film. Although a variety of materials may be used in various embodiments of the present invention, the use of nano size metallic particles, and particularly Ag and Ag—Pd particles, in the method of present invention is particularly contemplated. Ag and Ag—Pd particles will be used as illustrative examples herein.

The invention accordingly provides article of manufacture comprising a first electrode, a second electrode, and a dielectric material located between and separating the first electrode and the second electrode, wherein the thickness of at least one of the electrodes is less than about 700 nanometers, preferably less than about 200 nanometers.

The invention provides as well a method of manufacturing such articles, which comprises the steps of forming a film on a surface of a dielectric or green dielectric substrate, wherein the film comprises a plurality of nanoparticles, and sintering the nanoparticles so as to form an electrode less than about 700 nm in thickness and preferably less than about 200 nm in thickness.

In one embodiment, the method comprises the steps of forming a film on a surface of a carrier, wherein the film comprises a plurality of nanoparticles, contacting the film with a dielectric or green dielectric substrate so as to cause at least a portion of the film to adhere to the substrate; and then removing the carrier, thereby transferring the adherent portion of the film onto the substrate.

The average diameter of the nanoparticles is preferably between about 40 and about 80 nm, more preferably between about 20 and about 60 nm. In certain embodiments, the average diameter of the nanoparticles may be between about 10 and about 50 nm. The nanoparticles preferably comprise one or more elements selected from the group consisting of silver, gold, palladium, platinum, and copper.

Metallic particles may be obtained by various methods, such as subdivision of the bulk metal (e.g., milling and atomization), chemical and physical vapor deposition, and liquid phase chemical precipitation. Despite certain advantages of the vapor techniques (e.g., formation of highly crystalline metallic particles, and the possibility of obtaining truly alloyed particles of very dissimilar metals), they do not generally yield monodisperse, agglomeration-free powders, and their scale-up involves expensive equipment. Methods based on the chemical reduction of metal ions and reducing agents in the liquid phase, however, are known to be capable of producing monodisperse, highly non-agglomerated metallic particles over a very wide range of sizes at affordable costs. For example, ultra-fine metallic particles may be obtained in accordance with the methods disclosed in U.S. patent application Ser. No. 10/981,154, filed on Oct. 29, 2004, which is incorporated herein by reference in its entirety, and in international patent application No. PCT/US2005/39242. See also B. Pergolese et al., Appl. Spectrose., 59:194-199 (2005).

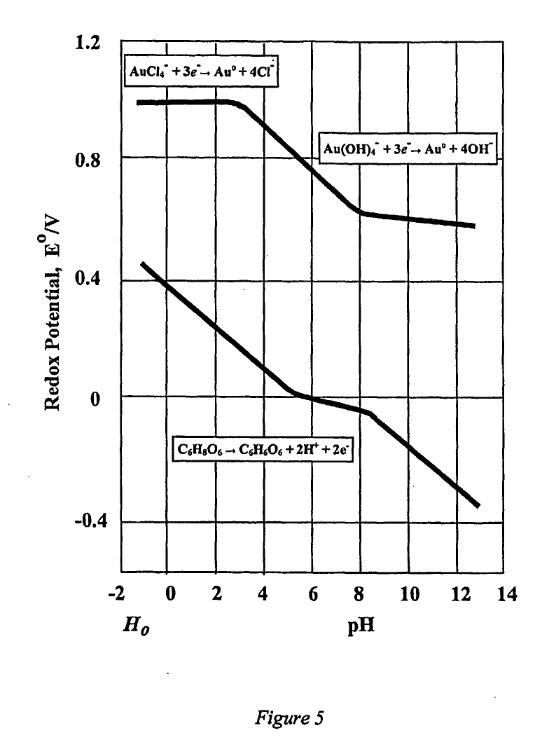

The formation of zero-valent metal atoms, the building blocks of the metallic particles, in a liquid medium is the result of the transfer of electrons from a reducing agent to metal ions. The driving force behind the reduction process is ΔE°, which determines the supersaturation concentration of the metal atoms, the nucleation rate, and ultimately the particle size. This important parameter may be tailored by changing the reactivity of the metal ions through complexation and by selecting an appropriate reducing agent from a large selection of candidate reagents (boranes, borohydrides, hydrazine, alcohols, formate, oxalate, ascorbate, carbohydrates, etc.). An example of how the ΔE° of one particular pair of reactants may be manipulated is illustrated in FIG. 5 for a gold/ascorbic acid system. Similar redox diagrams may be generated when two metals are involved, if bimetallic particles are being sought.

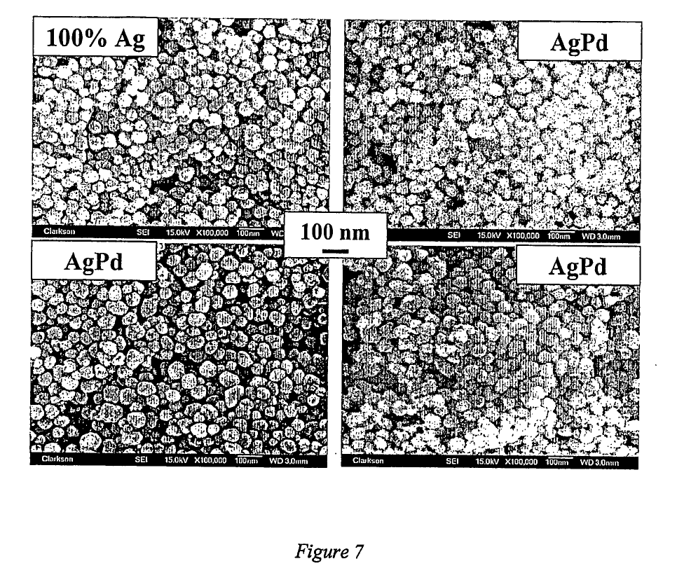

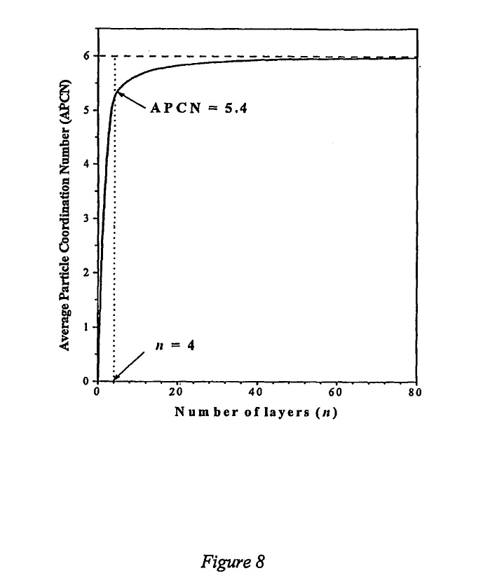

The conditions under which metal atoms resulting from the reduction reaction self-assemble into monodisperse metallic particles may be manipulated to obtain highly uniform metallic particles, with sizes from several nanometers to a few micrometers (see, e.g., FIGS. 7-8). The processes may also be manipulated (e.g., by controlling the nucleation and/or particle growth processes) to control the metallic particles' morphology, internal particle structure, internal composition, and surface properties. The number of nuclei formed in the system may depend on the critical supersaturation of atoms, which may be achieved by selecting the reducing agent used and/or by engaging the metal ions in complexes with suitable reactivity. The final particles may be formed either by diffusion growth or by aggregation of nanosize primary particles during the process. The first route, which generally leads to crystalline particles, may require a very effective stabilization during the entire precipitation process and experimental conditions in which the critical supersaturation may not be achieved following the initial burst of nuclei. Alternatively, monodisperse metallic particles may form by aggregation of nanosize precursors. In this scenario, the reaction conditions change during the course of the process may favor the attractive forces between the primary particles. The effect of various process parameters on particle size are known in the art; see for example D. Goia and E. Matijevic. Colloids and Surfaces A: Physicochemical and Engineering Aspects 146:139-152 (1999), and V. V. Provman et al., J. Colloid Interface Sci. 213(1):36-45 (1999).

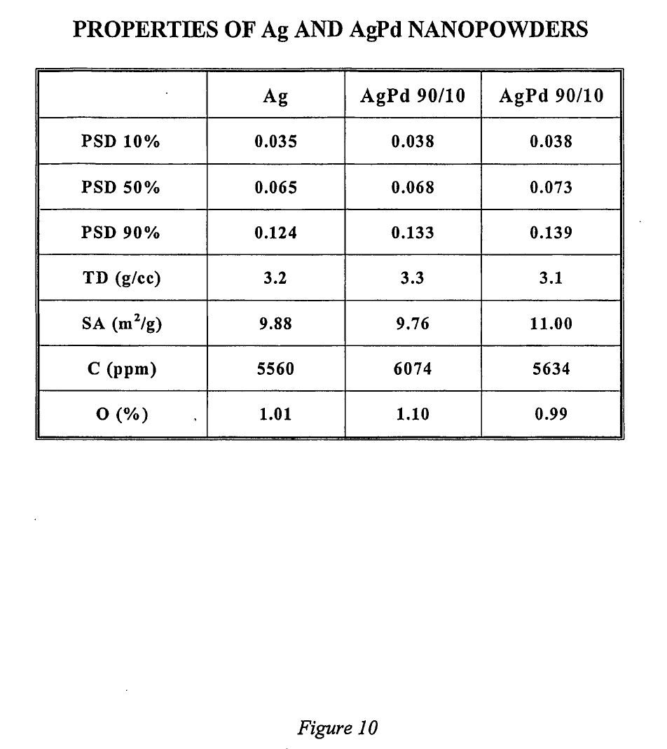

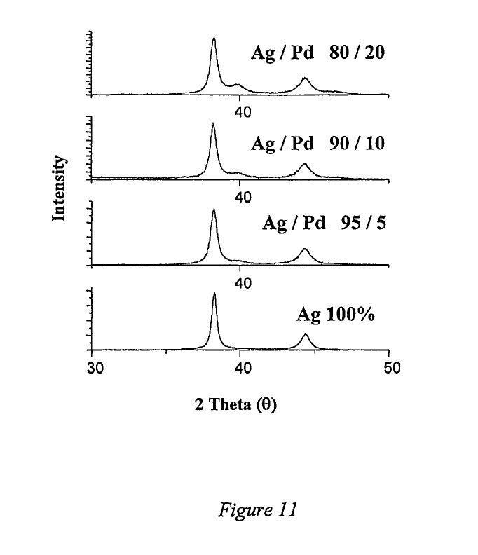

The packing properties of particles may be dependent on their ability to slide freely and occupy the optimal positions in a highly ordered close packed three-dimensional arrangement. In one embodiment, the processes are capable of producing non-agglomerated nanosize metallic particles and to keep them separated when incorporated into different liquid media (vehicles). For such particles the ratio between the mean values of the particle size distribution (PSD50%) and the particle diameter determined from electron microscopy measurements may be very close to unity. A larger value of this ratio indicates the tendency of the particles to agglomerate (see, e.g., FIGS. 10 and 11).

The preparation processes may be designed to yield spherical and highly uniform metallic particles, suitable to be assembled in ordered three-dimensional structures with very high packing densities. As a result of a high particle coordination number and uniform pore size in the arrangement, such materials are more readily and reliably converted by sintering into continuous, pore-free metallic layers displaying a high electrical conductivity. In one embodiment, metallic particles with a high degree of crystallinity may be used because the sintering of these highly crystalline metallic particles usually creates fewer problems during the consolidation of the metallic layers.

The suitable particle size for a desired final electrode thickness may be estimated based on theoretical considerations pertaining to the theories of sintering and packing of monodisperse spheres. Assuming a random loose packing of spherical particles in the green body with a packing efficiency of 52% and a final sintered density of 95%, the relation between their diameter d and the thickness of the sintered layer S may be expressed by:

$$d = \frac{δ}{0.7 {n ( 1.00 - 0.48 )}^{1 / 3} {( 1.00 - 0.05 )}^{1 / 3}}$$

where n represents the number of particle layers in the arrangement, and 0.7 is a correction factor reflecting the geometrical interpenetration of adjacent layers. The “Average Particle Coordination Number” (APCN), a critical factor in the sintering process, increases from 3 in a perfect monolayer arrangement of monodisperse spherical particles to 6 for a very large n (bulk). As shown in FIG. 8, when n is >4, the APCN, and, therefore, the sintering conditions, may be similar to that of the ‘bulk-type.’ if more layers of particles are present (n>6), potential benefits of an increased APCN may be offset by the problems created by the increased surface reactivity associated with the decrease of the particle size if the final thickness is to be kept constant. Thus, it is possible to calculate, when practicing the present invention, preferred particle sizes or preferred deposited layer thickness for a given desired electrode thickness. For example, based on this equation, for a deposit consisting of five layers of metallic particles (n=5), their sizes may be about 72 nm if the desired thickness of the electrode is 200 nm and about 55 nm if desired thickness of the electrode 150 nm.

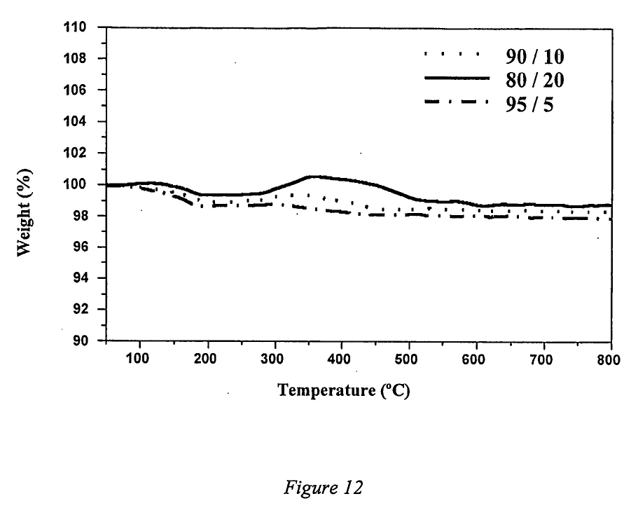

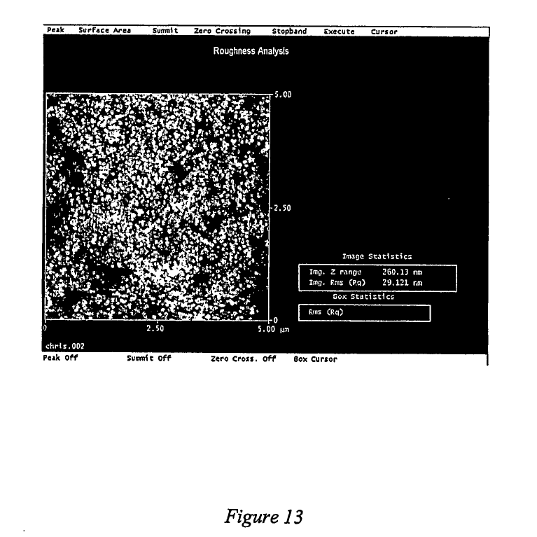

The present invention provides precipitation processes capable of producing monodisperse particles of various metals, such as, Ag and Ag/Pd, the metals most frequently used as thick film conductors in electronic applications (e.g., MLCC electrodes). Unlike pure Ag particles, bimetallic Ag—Pd particles may be obtained either as core/shell or homogeneous compositions (alloys), depending on the relative reactivity of the two metallic ions and the experimental conditions. Alloy particles with a Pd content in excess of about 25% tend to oxidize and expand less, whereas if the Ag content exceeds 80% the volume expansion associated with the formation of Ag₂O may become an issue in the manufacturing of MLCCs. The presence of a Pd shell generally tends to minimize the problems associated with a pure silver surface (e.g., oxidation, malleability and migration), therefore, in one embodiment, silver particles coated with palladium may be used in the methods of the present invention for making MLCCs (see, e.g., FIGS. 12 and 13).

The present invention also provides highly concentrated precipitation systems (5-20% w/w metal) which, when scaled up, yield nanosize metallic powders at manufacturing costs that may be comparable to the existing materials sold in the market place. Various additives may be added to the systems, such as natural and synthetic polysaccharides (e.g. gum Arabic, starch, and amino-dextrans), buffering agents, counter-ions, and copolymers of naphthalene sulfonic acid with formaldehyde, to improve the stability of the metallic particle dispersions.

There are methods known in the art for removal of the by-products of the chemical reactions (excess dispersant, spent and/or unreacted reducing agents, electrolytes, etc.) from dispersions of metallic particles. In one embodiment, this may be accomplished by the rapid and reversible coagulation/peptization of the colloidal dispersion. For example, increasing the ionic strength or working in the proximity of the isoelectric point (IP) may induce reversible coagulation of the stable dispersion, resulting in a floe which may be easily separated from the liquid containing the excess solutes. By selecting the proper conditions, the particles may be subsequently peptized to form stable dispersions of metallic particles in the solvent of choice. In this process, the electrokinetic properties (e.g. the zeta potential) of the dispersed matter will play a pivotal role; these may be evaluated by phase analysis light scattering (PALS) and other techniques, as reviewed by A. V. Delgado et al., Pure Appl. Chem. 77:1753-1805 (2005). The purification of dispersions of finely dispersed nanosize metal oxides may also be achieved using various filtration techniques, as well as centrifugation, and it is known that ferromagnetic and paramagnetic particles may be separated from dissolved contaminants and diamagnetic particles by magnetic separation technologies.

The nanosize metallic particles are preferably dispersed in liquid vehicles which are compatible with their transport, storage, and eventual conversion into ultrathin close-packed deposits on a desired substrate. For these purposes, the vehicle should be able to maintain the particles fully dispersed for appreciable lengths of time. The metallic particles prepared and processed in accordance with an embodiment of the present invention may be dispersed in water. The rheology and the evaporative properties required for the rapid deposition of thin films will be adjusted by controlling the concentration of the metal phase and through the addition of various polyols and surfactants. Alternatively, the metallic particles prepared and processed in accordance with an embodiment of the present invention may be dispersed in alcohols, as these solvents have fast drying rates that will be needed during the deposition of the particles in the mass production of MLCCs. To transfer the particles from water to an alcohol may require the uses of suitable surfactants. The evaporative properties of the solvent may be tailored by mixing alcohols of different molecular weight.

The dispersion may also contain one or more polymers (e.g., binders and dispersants). Binders are capable, once the solvent has evaporated, of holding the assembly of particles together. The concentration of any such additives is preferably such that their volume in the final dried film does not exceed the volume of the pores formed in the closely packed arrangement of spherical particles. The molecular weight of the polymers is preferably low enough to avoid a significant increase in the viscosity of the film and to avoid the agglomeration of the particles at the late stages of the drying process.

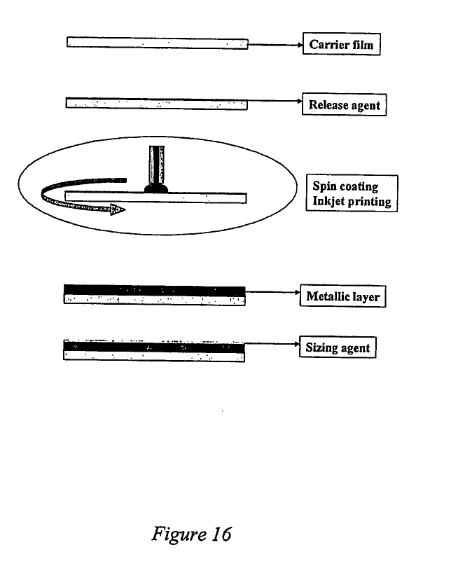

A number of techniques may be used to deposit thin assemblies of closely packed deposits of metallic particles directly on a green dielectric layer, or on a carrier film. The selected method should be capable of depositing a thin layer of the particle dispersion which yields, after the evaporation of the solvent, a closely packed assembly of metallic particles consisting of 4-12 layers of particles, and preferably 4-6 layers. Five closely packed layers of 60 nm particles of Ag—Pd (80%/20%, p=11.00 g/cm³), which will yield a 200 nm thick metallic film, correspond to a metal coverage of slightly less than 0.2 mg metal/cm² of substrate. For comparison, the lowest surface coverage obtainable in mass produced capacitors using techniques known in the art, such as by conventional screen-printing, is ˜0.8 mg/cm². Technologies capable of achieving this level of performance include, without limitation, spin coating, spray coating, and various printing technologies such as letterpress, offset lithography, gravure printing, flexography, recess printing, and inkjet printing. The list of materials from which a carrier film may be made includes but is not restricted to Mylar™ and other polyesters, while its thickness will be dictated by the specific conditions of each application. The deposition process of the metallic particles on the carrier film is presented schematically in FIG. 16.

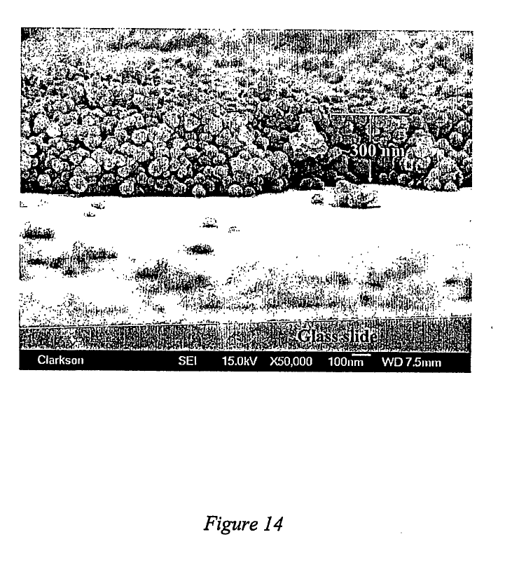

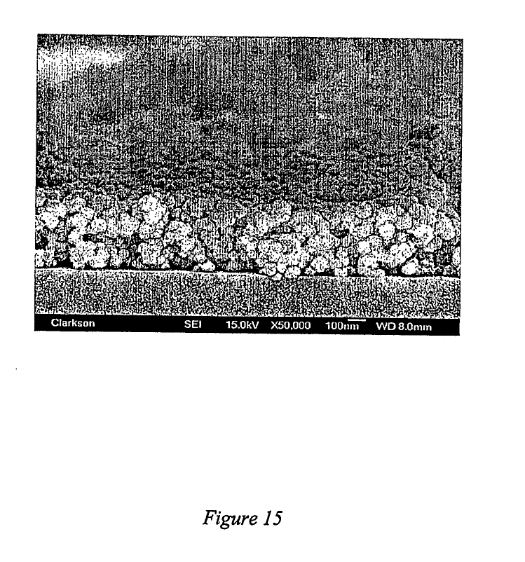

Prior the deposition of the metallic layer by spin coating, the surface of a carrier film may be coated with a very thin layer of a release agent. This agent may improve the adherence of the metallic layer to the carrier film and allow its separation only from selected regions where the right combination of temperature and/or pressure are applied. In one embodiment, a sizing agent may be applied as a very thin film on the external surface of the deposited metallic film, which may facilitate the bonding between the metallic layer and the dielectric tape during the subsequent transfer process. Optionally, polymers that may promote strong interactions with the binder used in the dielectric tape may be added directly in the dispersion of metallic particles. All other characteristics of the dispersions (composition, drying properties, rheological behavior, concentration of solids, etc.) will be tailored depending on the deposition technology used to achieve the optimum packing density of the metallic particles and the desired final thickness of the deposit. The packing properties of the Ag—Pd particles in the resulting film may be evaluated by observing the cross section and the top surface of the green film by electron microscopy. For illustration, FIGS. 14 and 15 show a deposit obtained by dip coating a functionalized glass slide in a dispersion of ca. 70 nm Ag particles in water and allowing it to dry.

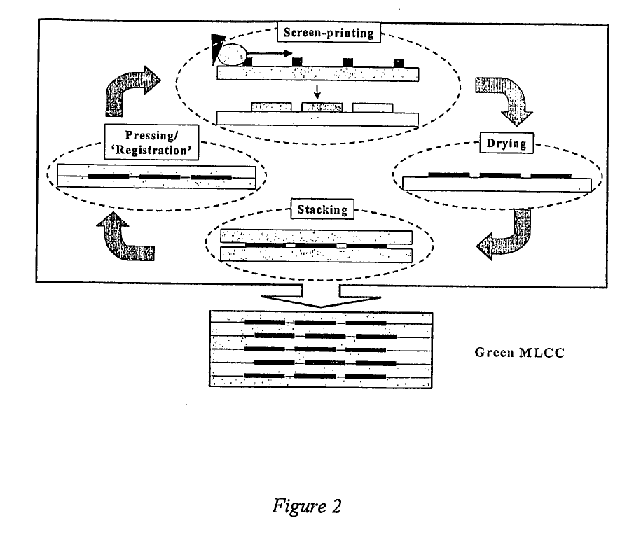

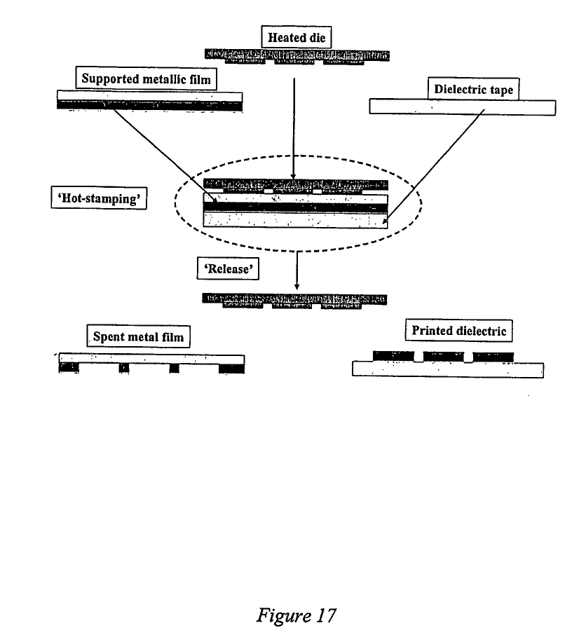

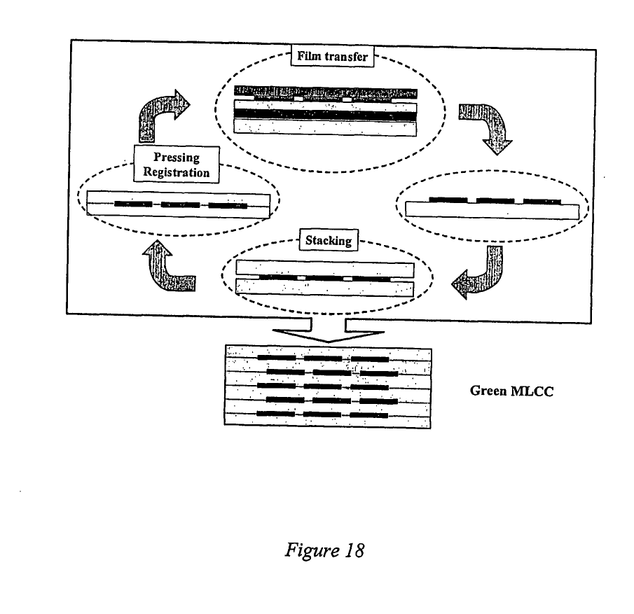

Once deposited on a carrier film, the ‘green’ conductive layer may be transferred onto the substrate of choice (e.g., a barium titanate ceramic tape) by various methods. One technique, which may achieve the deposition in complex patterns and at high throughput, is the hot stamping technique. Using this technology, the green conductive layer will be transferred from the carrier film onto the desired substrate with the help of a die on which the desired pattern is engraved. The temperature of the die and the pressure applied may be adjusted to ensure a rapid release of the layer from the film only in the areas where the die comes in contact with the carrier. The transfer process is presented schematically in FIG. 17. By combining these two elements of the proposed technology, the supported metallic film and the hot-press transfer, it is possible to have a very simple process to construct at high speed the multilayer structure of the MLCC (see, e.g., FIG. 18). Since this novel process is very similar to the existing state-of-the-art process as illustrated in FIG. 2, it may be integrated into existing manufacturing lines of MLCCs with minimal disruption of existing infrastructure.

The thin ‘green’ assembly of closely packed metallic particles may be converted into continuous metallic films following the removal of any organic matter (e.g. binders and dispersants), and the sintering of the particles at an appropriate temperature. In one embodiment, the process generates a continuous, uniform, metallic film, which has an average thickness between 2 and 700 nm and displays good electrical conductivity. For example, thin green layers having Ag or Ag—Pd particles may be deposited as large (5 cm×5 cm) rectangular patches on a smooth substrate. The samples will be placed in a furnace where the temperature will be increased using a suitable profile to ensure the decomposition of the residual organic matter in the green film and the sintering of the metallic particles. For instance, a typical profile for manufacturing Ag—Pd electrodes includes increasing the temperature at a rate of ˜2° C./min to 350-380° C., maintaining the temperature for a period of up to three days to decompose high molecular weight resin present in the thick film paste, and, finally, increasing the temperature rapidly to the firing temperature. The firing temperature varies with the composition of Ag—Pd used but is usually about 30 to 60° C. below the melting point of an alloy with the same ratio of metals (from 900° C. for pure Ag to as high as 1340° C. for high content Pd compositions). In one embodiment, the dispersions contains only minimum amounts of a clean-burning, lower molecular weight polymer, which may reduce the time necessary for the removal of the organics. Furthermore, the use of nanosize particles having size of less than about 100 nm may also help to reduce the temperature needed to fully sinter the assembly. As a result, the typical processing cycle of the multi-layered components may be shortened and may be carried out at overall lower temperatures. These effects may translate into significant energy and cost savings. To minimize the sintering mismatch and ensure the consolidation of metallic particles in a continuous film adherent to a dielectric layer, the sintering behavior of the metallic particles may be altered to match those of the ceramic particles, for example by encapsulating the metallic particles in a very thin ceramic film, as is known in the art.

By improving only the materials involved and overhauling only the screen printing step, the present invention enables existing manufacturing plants, representing hundreds of millions dollars in fixed assets, to produce lower cost devices and components with a higher level of sophistication and performance. In contrast, the implementation of the vapor deposition approach to achieve a comparable outcome would demand a major investment to replace a significant part of the existing manufacturing lines. Furthermore, the significant reduction in the content of metal incorporated into each component may also have a positive environmental impact, by slowing or even reversing the present trend of increased use of base metals in MLCCs. The increase in popularity of the nickel-based electrodes has been, and still is, largely triggered by the lower cost of this metal as compared to that of the noble metals. However, the prospect of having this toxic metal incorporated into every electronic device from children's toy to consumer electronics (e.g., cellular phones) raises public health concerns and long-term environmental issues. The novel materials and processes of the present invention may be applied in making a wide variety of devices. For example, nanosize monodisperse particles may be assembled to form thin films on the surface of various devices, such as the deposition of thin films of transparent conductive coatings of ITO, ATO, or Ag, or the assembly of pigment particles in ultrathin layers which may function as color filters or photonics devices.

While the foregoing invention has been described in some detail for purposes of clarity and understanding, one skilled in the art, from a reading of the disclosure, will appreciate that various changes in form and detail may be made without departing from the true scope of the invention in the appended claims.

1. An article of manufacture comprising a first electrode, a second electrode, and a dielectric material located between and separating the first electrode and the second electrode, wherein the thickness of at least one of the electrodes is less than about 700 nanometers.

2. The article of manufacture of claim 1, wherein the thickness of at least one of the electrodes is less than about 200 nanometers.

3. The article of manufacture of claim 1, wherein the article is selected from the group consisting of a capacitor, a varistor, an EMI filter, and an ESD filter.

4. A method of manufacturing an article comprising a first electrode, a second electrode, and a dielectric material located between and separating the first electrode and the second electrode, wherein the thickness of at least one of the electrodes is less than about 700 nanometers, comprising:
(a) forming a film on a surface of a dielectric or green dielectric substrate, wherein the film comprises a plurality of nanoparticles; and
(b) sintering the nanoparticles so as to form an electrode less than about 700 nm in thickness.

5. The method of claim 4, wherein the nanoparticles are sintered so as to form an electrode less than about 200 nm in thickness.

6. A method of manufacturing an article comprising a first electrode, a second electrode, and a dielectric material located between and separating the first electrode and the second electrode, wherein the thickness of at least one of the electrodes is less than about 700 nanometers, comprising:
(a) forming a film on a surface of a carrier, wherein the film comprises a plurality of nanoparticles;
(b) contacting the film with a dielectric or green dielectric substrate, whereby at least a portion of the film adheres to the substrate; and
(c) removing the carrier, thereby transferring the adherent portion of the film onto the substrate, and
(d) sintering the nanoparticles so as to form an electrode less than about 700 nm in thickness.

7. The method of claim 6, wherein the nanoparticles are sintered so as to form an electrode less than about 200 nm in thickness.

8. The method of claim 4, wherein the article is selected from the group consisting of a capacitor, a varistor, an EMI filter, and an ESD filter.

9. The method of claim 4, wherein the average diameter of the nanoparticles is between about 10 nm and about 80 nm.

10-11. (canceled)

12. An article prepared by the method of claim 4, wherein the nanoparticles comprise one or more elements selected from the group consisting of silver, gold, palladium, platinum, and copper.

13. A capacitor prepared by the method of claim 4, wherein the nanoparticles comprise one or more elements selected from the group consisting of silver, gold, palladium, platinum, and copper.

14. The method of claim 6, wherein the article is selected from the group consisting of a capacitor, a varistor, an EMI filter, and an ESD filter.

15. The method of claim 6, wherein the average diameter of the nanoparticles is between about 10 nm and about 80 nm.

16-18. (canceled)

19. An article of claim 12, wherein the article is selected from the group consisting of a capacitor, a varistor, an EMI filter, and an ESD filter.

20. An article of claim 12, wherein the average diameter of the nanoparticles is between about 10 nm and about 80 nm.

21-22. (canceled)

23. An article prepared by the method of claim 6, wherein the nanoparticles comprise one or more elements selected from the group consisting of silver, gold, palladium, platinum, and copper.

24. (canceled)

25. An article of claim 23, wherein the article is selected from the group consisting of a capacitor, a varistor, an EMI filter, and an ESD filter.

26. An article of claim 23, wherein the average diameter of the nanoparticles is between about 10 nm and about 80 nm.

27-28. (canceled)

29. A capacitor of claim 13, wherein the nanoparticles are sintered so as to form an electrode less than about 200 nm in thickness.

30. A capacitor of claim 13, wherein the article is selected from the group consisting of a capacitor, a varistor, an EMI filter, and an ESD filter.

31. A capacitor of claim 13, wherein the average diameter of the nanoparticles is between about 10 nm and about 80 nm.

32-33. (canceled)

34. A capacitor prepared by the method of claim 6, wherein the nanoparticles comprise one or more elements selected from the group consisting of silver, gold, palladium, platinum, and copper.

35. A capacitor of claim 34, wherein the nanoparticles are sintered so as to form an electrode less than about 200 nm in thickness.

36. A capacitor of claim 34, wherein the article is selected from the group consisting of a capacitor, a varistor, an EMI filter, and an ESD filter.

37. A capacitor of claim 34, wherein the average diameter of the nanoparticles is between about 10 nm and about 80 nm.

38-39. (canceled)
